(19) United States
(12) Patent Application Publication
(10) Pub. No.: US 2008/0075686 A1
(43) Pub. Date: Mar. 27, 2008

(54) Deodorizer and method for using the same

(76) Inventors: Hiroyuki Fujii, Chigasaki-shi (JP); Yoko Yamada, Chigasaki-shi (JP); Mitsuyoshi Kanno, Chigasaki-shi (JP)

Correspondence Address: CARRIER BLACKMAN AND ASSOCIATES, 24101 NOVI ROAD, SUITE 100, NOVI, MI, 48375, US

(21) Appl. No.: 11/879,205

(22) Filed: Jul. 16, 2007

(30) Foreign Application Priority Data
Jul. 14, 2006 (JP) 2006-194679
Feb. 1, 2007 (JP) PCT/JP2007/051709

(51) Int. Cl. B01D 11/00

(52) U.S. Cl. 424/76.1

(57) ABSTRACT

A deodorizer is disclosed which is superior both in odor elimination effect eliminating an already existing odor and in odor prevention effect preventing odor occurrence, without leaving a colored trace on an application site. The deodorizer of the present invention comprises a salt of copper (II) ion and/or zinc ion; at least one acid component selected from the group consisting of alkylsulfonic acids having 1 to 6 carbon atoms, arylsulfonic acids having 5 to 14 carbon atoms, amidosulfuric acids, and derivatives thereof; and water being a solvent. The acid component may be substituted by at least one selected from the group consisting of amine groups, imine groups, and hydroxyl group. The deodorizer comprises the salt in an amount of more than 0.001 mM and less than 10 mM.

### TECHNICAL FIELD

The present invention relates to a deodorizer and a method for using the same, which are suitable for use in an area or in a space out of contact with water under normal use conditions, in particular, for deodorizing toilets, baby-related products, pet-related products, caring-related products, and nursing-related products.

### GROUND ART

In recent years, due to consumers' growing concern about their living environment, it has been more required than ever before to remove offensive odors from personal environment. In particular, nitrogen-based odors such as amines or ammonia and sulfur-based odors such as methyl mercaptan have properties such as a fishy smell or a strong irritation of the nasal cavity, resulting in malodor offensive to everyone. As one of the techniques for preventing the occurrence of these offensive odors, a method for preventing the occurrence of an ammonia-based odor component is known in which running water comprising free chlorine is used to inhibit the decomposition of urea by the enzyme urease (see Patent Document 1, for example).

The following techniques are known for deodorizing with a metal salt. Specifically, it is known to absorb and remove nitrogen-based and sulfur-based malodorous substances by use of a liquid antimicrobial and deodorizing agent comprising copper gluconate (see Patent Document 2, for example). It is also known to deodorize N-based and S-based malodors from industrial wastes by use of a deodorizer comprising a zinc compound such as zinc gluconate and a nonionic surfactant (see Patent Document 3, for example).

The following techniques are known for deodorizing with an acid. Specifically, it is known to neutralize amine or sulfide as odor compounds by use of an acid, such as phosphoric acid, hydrochloric acid, and citric acid, so as to reduce its volatility for deodorization (see Patent Document 4, for example). It is also known to deodorize formaldehyde and the like by use of a deodorizer comprising an aliphatic primary amine having a sulfonic group, such as aminoethanesulfonic acid (taurine), supported by a porous carrier such as a magnesium silicate clay mineral (see Patent Document 5, for example). It is further known to remove a chlorine odor from tap water and the like by use of a nitrogen-containing organic compound such as taurine (see Patent Document 6, for example).

Patent Document 1: W096/6237

Patent Document 2: Japanese Patent Laid-Open Publication No. 1996-198709

Patent Document 3: Japanese Patent Laid-Open Publication No.2001-321427

Patent Document 4: Japanese Patent Laid-Open Publication No.2001-37861

Patent Document 5: Japanese Patent Laid-Open Publication No.2000-107274

Patent Document 6: Japanese Patent Laid-Open Publication No. 1995-138552

### SUMMARY OF THE INVENTION

The inventors have now found that a deodorizer can be attained which is superior both in odor elimination effect eliminating an already existing odor and in odor prevention effect preventing odor occurrence, without leaving a colored trace on an application site, by incorporating into water being a solvent a salt of copper (II) ion and/or zinc ion as well as at least one acid component selected from the group consisting of certain alkylsulfonic acids, certain arylsulfonic acids, amidosulfuric acids, and derivatives thereof.

Accordingly, it is an object of the present invention to provide a deodorizer which is superior both in odor elimination effect eliminating an already existing odor and in odor prevention effect preventing odor occurrence, without leaving a colored trace on an application site.

A deodorizer according to the present invention comprises:
a salt of copper (II) ion and/or zinc ion;
at least one acid component selected from the group consisting of alkylsulfonic acids having 1 to 6 carbon atoms, arylsulfonic acids having 5 to 14 carbon atoms, amidosulfuric acids, and derivatives thereof, wherein the acid component may be substituted by at least one selected from the group consisting of amine groups, imine groups, and hydroxyl group; and
water being a solvent,
wherein the deodorizer comprises the -salt in an amount of more than 0.001 mM and less than 10 mM.

A method of using a deodorizer according the present invention comprises a step of applying the above deodorizer to either an area or a space out of contact with water under normal use condition.

### DETAILED DESCRIPTION OF THE INVENTION

Deodorizer

The deodorizer according to the present invention comprises a salt of copper (II) ion and/or zinc ion, a certain acid component, and water being a solvent. The certain acid component is at least one selected from the group consisting of alkylsulfonic acids, arylsulfonic acids, amidosulfuric acids, and derivatives thereof, provided that the alkylsulfonic acids and the arylsulfonic acids have 1 to 6 carbon atoms and that the acid component may be substituted by at least one selected from the group consisting of amine groups, imine groups, and hydroxyl group. The salt of copper (II) ion and/or zinc ion effectively prevents odor occurrence, particularly the occurrence of a nitrogen-based odor, such as trimethylamine or ammonia. A hypothetical reason for this, to which the present invention is not at all limited, is that these metal ions inhibit the enzyme activity of urease or the like being a urea hydrolytic enzyme, which contributes to the production of odorous substances. On the other hand, the acid component neutralizes and eliminates a nitrogen-based odor, such as trimethylamine or ammonia. It is generally known that various acids and their derivatives have neutralization properties of eliminating a nitrogen-based odor while the copper (II) ion and/or zinc ion eliminate a sulfur-based odor, such as methyl mercaptan. However, in the case of the combined use of these acids and the salt of the copper (II) ion and/or zinc ion, these metal ions tend to be bonded to an acid, such as a carboxyl group, through chelation or the like, resulting in a significant reduction in the net amount of metal ions contributing to the odor prevention or the odor elimination. Further, even if a large amount of metal salt is added in order to compensate for the loss, the resulting liquid agent is strongly colored by the high concentration of metal ions to leave a colored trace on the application site when used, deteriorating the aesthetic appearance. This may degrade the value as a consumer product because the colored trace is not washed away with water in an area out of contact with water under normal use conditions. In the deodorizer according to the present invention, the above problems can be solved by employing as the acid component at least one selected from the group consisting of the certain alkylsulfonic acids and arylsulfonic acids as described above, amidosulfuric acids, and derivatives thereof, while it is possible to fully exercise both odor elimination effect eliminating an already existing odor and in odor prevention effect preventing odor occurrence by simply adding a salt of copper (II) ion and/or zinc ion so that its concentration can be a very low level of more than 0.001 mM and less than 10 mM. In addition, the metal salt component, which is of a low concentration as described above, does not leave a colored trace on the application site.

The salt component used in the deodorizer of the present invention is a salt of copper (II) ion and/or zinc ion. The concentration of the salt component in the deodorizer is in a range of more than 0.001 mM and less than 10 mM, preferably from 0.005 mM to 5 mM, more preferably from 0.01 mM to 2 mM, and most preferably from 0.1 mM to 1 mM. Due to these very low concentrations, a colored trace to be caused by the copper (II) ion and/or zinc ion is not left at all, or hardly at all. In addition, in spite of such a low concentration, the deodorizer can exercise a superior odor prevention effect through the inhibition of the enzyme activity, which contributes to the production of odorous substances.

According to a preferred embodiment of the present invention, preferred examples of the salt of a copper (II) ion and/or zinc ion include gluconates, sulfates, malates, and lactates. From the viewpoint of safety for humans, the salt is preferred to have a LD50 (50% effective dose) of 300 to 2000 mg/kg, while the above preferred salts fall within this preferable LD50 range. In particular, copper gluconate and zinc gluconate are preferable due to their high safety to human in view of the facts that these gluconates are both designated as food additives and that nutritional supplements using these salts are currently on the market.

The acid component used in the deodorizer of the present invention may be at least one selected from the group consisting of alkylsulfonic acids having 1 to 6 carbon atoms, arylsulfonic acids having 5 to 14, preferably 6 to 10, carbon atoms, amidosulfuric acids, and derivatives thereof, provided that the acid component may be substituted by at least one selected from the group consisting of amine groups, imine groups, and hydroxyl group. According to a preferred embodiment of the present invention, the derivatives preferably do not have a chain hydrocarbon group having 7 or more carbon atoms in its molecular structure. In addition, according to a preferred embodiment of the present invention, the alkylsulfonic acids and the arylsulfonic acids are preferably selected from the group consisting of compounds represented by the following chemical structural formulas:
R¹—SO₃H (1)
wherein R¹ is an alkyl group having 1 to 6 carbon atoms or an aryl group having 5 to 14, preferably 6 to 10, carbon atoms; and 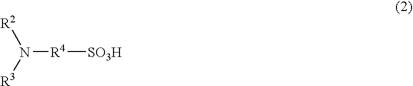
wherein R² and R³ are independently a hydrogen atom, an amine group, a hydroxyl group, a sulfonic group, a hydrocarbon group (preferably alkyl group) having 1 to 6 carbon atoms, or an aryl group having 5 to 14, preferably 6 to 10, carbon atoms, wherein at least one hydrogen atom of the alkyl group and the aryl group may be substituted by a hydroxyl group, an amine group, or a sulfonic group, provided that R² and R³ may be linked together. R⁴ is an alkyl group having 1 to 6-carbon atoms or an aryl group having 5 to 14, preferably 6 to 10, carbon atoms, provided that at least one hydrogen atom of the alkyl group and the aryl group may be substituted by a hydroxyl group, an amine group, or a sulfonic group. More preferably, the alkylsulfonic acid and the arylsulfonic acid do not comprise a carbonyl group or a carboxyl group. With such compounds, there is no possibility of inhibiting the performance of preventing odor and that of eliminating a sulfur-based odor (e.g., methyl mercaptan), both of which are attained by metal ions.

According to a preferred embodiment of the present invention, the alkylsulfonic acid and/or arylsulfonic acid are preferably a compound represented by the following chemical structural formula or a derivative thereof:
R¹—SO₃H (1)
wherein R¹ is an alkyl group having 1 to 6 carbon atoms, an aryl group having 5 to 14, preferably 6 to 10, carbon atoms, or an amine group having 1 to 6 carbon atoms. Examples of the compounds of the alkylsulfonic acid and arylsulfonic acid include benzenesulfonic acid, benzenesulfonic acid monohydrate, methanesulfonic acid, ethanesulfonic acid, propanesulfonic acid, butylsulfonic acid, penthylsulfonic acid, hexylsulfonic acid, 4-biphenylsulfonic acid, 1,2-ethanedisulfonic acid, and mixtures thereof, more preferably benzenesulfonic acid. Examples of the derivatives of the alkylsulfonic acid and arylsulfonic acid include dimethanesulfonic acid 1,4-butanediol, p-toluenesulfonic acid n-butyl, p-toluenesulfonic acid 2-butynyl, p-toluenesulfonic acid 3-butynyl, 2,5-dimethylbenzenesulfonic acid dihydrate, benzenesulfonic acid ethyl, 2-hydroxyethylsulfonic acid ethyl, methanesulfonic acid ethyl, p-toluenesulfonic acid ethyl, bis-p-t-toluenesulfonic acid ethylene glycol, toluenesulfonic acid, 2,4,6-trimethylbenzenesulfonic acid, and mixtures thereof.

According to a preferred embodiment of the present invention, the alkylsulfonic acid and/or arylsulfonic acid are preferably either a compound represented by the following chemical structural formula or a derivative thereof: 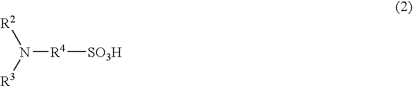
wherein R² and R³ are independently a hydrogen atom, an amine group, a hydroxyl group, a sulfonic group, a hydrocarbon radical having 1 to 6 carbon atoms, or an aryl group having 5 to 14, preferably 6 to 10, carbon atoms, wherein at least one hydrogen atom of the alkyl group and the aryl group may be substituted by a hydroxyl group, an amine group, or a sulfonic group, provided that R² and R³ may be linked together to form a cyclic structure, and wherein R⁴ is an alkyl group having 1 to 6 carbon atoms or an aryl group having 5 to 14, preferably 6 to 10, carbon atoms, provided that at least one hydrogen atom of the alkyl group and the aryl group may be substituted by a hydroxyl group, an amine group, or a sulfonic group. Examples of the aminosulfonic acid, the aminoalkylsulfonic acid and the aminoarylsulfonic acid include aminomethanesulfonic acid, aminoethanesulfonic acid, aminopropanesulfonic acid, m-aminobenzenesulfonic acid, o-aminobenzenesulfonic acid, sulfanilic ‘acid, 8-amino-2-naphthalenesulfonic acid, 5-amino-2-naphthalenesulfonic acid, 6-amino-1-naphthalenesulfonic acid, 4-aminonaphthalene-1-sulfonic acid, 1-aminonaphthalene-5-sulfonic acid, 5-aminonaphthalene-2-sulfonic acid, 8-aminonaphthalene-1-sulfonic acid, aminoamylsulfonic acid, N-phenylaminomethanesulfonic acid, and mixtures thereof, more preferably aminoethanesulfonic acid and aminomethanesulfonic acid. Examples of the derivative of the aminoalkylsulfonic acid and the aminoarylsulfonic acid include 5-(2-aminoethylamino)-1-naphthalenesulfonic acid, 5-amino-2-[(p-aminophenyl)amino]benzenesulfonic acid, 3-amino-4-hydroxybenzenesulfonic acid, 4-amino-3-hydroxy-1-naphthalenesulfonic acid, 2-amino-5-methylbenzene-1-sulfonic acid, 4-amino-2-methylbenzene-1-sulfonic acid, 5-amino-2-methylbenzene-1-sulfonic acid, 2-amino-5-methylbenzene-1-sulfonic acid, 2-aminotoluene-5-sulfonic acid, 5-amino-2-methylbenzenesulfonic acid, 2-amino-1,5-naphthalenedisulfonic acid, 7-amino-1,3,6-naphthalenetrisulfonic acid, 1-amino-2-naphthol-4-sulfonic acid, 6-amino-1-naphthol-3-sulfonic acid, 1-amino-2-naphthol-4-sulfonic acid, 4-amino-4′-nitrostilbene-2,2′-disulfonic acid, 2-amino-4-nitrotoluene-5-sulfonic acid, 4-amino-2-nitrotoluene-3-sulfonic acid, 2-aminopyridine-5-sulfonic acid, 2-amino-5-pyridinesulfonic acid, 3-amino-2-pyridinesulfonic acid, 4-aminopyridine-3-sulfonic acid, 6-amino-2-pyridinesulfonic acid, 4-aminotoluene-3-sulufonic acid, 3-[(1,1-dimethyl-2-hydroxyethyl)amino]-2-hydroxypropanesulfonic acid, aniline-2,4-disulfonic acid, 8-anilino-1-naphthalenesulfonic acid, 8-anilino-1-naphthalenesulfonic acid, 2-anilinonaphthalene-6-sulfonic acid, p-anisidine-2-sulfonic acid, p-anisidine-3-sulfonic acid, 1H-benzimidazole-2-sulfonic acid, N,N-bis(2-hydroxyethyl)-2-aminoethanesulfonic acid, 2-(N-cyclohexylamino)ethanesulfonic acid, N-cyclohexyl-2-aminoethanesulfonic acid, N-cyclohexyl-3-aminopropanesulfonic acid, 2,5-diamino-1,3-benzenesulfonic acid, 4,4′-diamino-2,2′-biphenyldisulfonic acid, 3,5-diamino-2,4,6-trimethylbenzenesulfonic acid, 1-diazo-2-naphthol-4-sulfonic acid, 5-dimethylamino-1-naphthalenesulfonic acid, N-ethyl-N-benzylaniline-3′-sulfonic acid, p-hydroxyazobenzene-p’-sulfonic acid, 3-amino-4-hydroxy-5-nitrobenzenesulfonic acid monohydrate, 3-pyridinesulfonic acid, 2-methylarylsulfonic acid ammonium, 1-anilinonaphthalene-8-sulfonic acid, 2-anilinonaphthalene-6-sulfonic acid, benzotriazole-4-sulfonic acid, 4-benzoylamide-4′-aminostilbene-2,2′-disulfonic acid trihydrate, 3-pyridinesulfonic acid, 4,4′-diaminostilbene-2,2′-disulfonic acid, diammonium imidodisulfonate, α-(N-ethylanillino)-m-toluenesulfonic acid, 1,1-di(aminoethyl)ethanesulfonic acid, 1,1-diaminomethanesulfonic acid, 1,1-diaminopropanesulfonic acid, 1,2-diaminopropanesulfonic acid, 2-amino-1,5-naphthalenedisulfonic acid, 2-amino-1,4-benzenesulfonic acid, 4-amino-5-methoxy-2-methylbenzenesulfonic acid, 2-amino-5-methylbenzene-1-sulfonic acid, 4-amino-2-methylbenzene-1-sulfonic acid, 5-amino-2-methylbenzene-1-sulfonic acid, 1-amino-3,8-naphthalenedisulfonic acid, 3-amino-1,5-naphthalenedisulfonic acid, 4-aminonaphthalene-1-sulfonic acid, 4-amino-1-naphthalenesulfonic acid, 6-amino-1-naphthalenesulfonic acid, 5-amino-1-naphthalenesulfonic acid, 1-amino-8-naphthalenesulfonic acid, 4-aminonaphthalene-1-sulfonic acid, 5-aminonaphthalene-1-sulfonic acid, 8-aminonaphthalene-1-sulfonic acid, 7-amino-1,3,6-naphthalenetrisulfonic acid, 8-amino-1-naphthol-3,6-disulfonic acid, 4-amino-5-naphthol-2,7-disulfonic acid, 1-amino-2-naphthol-4-sulfonic acid, 1-amino-5-naphthol-7-sulfonic acid, 4-amino-3-methylbenzene-1-sulfonic acid, aniline-2,5-disulfonic acid, azolitmin, N,N-bis(2-hydroxyethyl)-2-aminoethanesulfonic acid, 4,4-bis(4-amino-1- naphthylazo)-2,2-stilbenedisulfonic acid, 4,4-diaminostilbene-2,2-disulfonic acid, metanilic acid, 1-naphtylamino-6-sulfonic acid, 4-nitroaniline-2-sulfonic acid, trypan blue, diaminobenzenesulfonic acid, 4,4-diaminostilbene-2,2-disulfonic acid, and mixtures thereof.

According to a preferred embodiment of the present invention, the alkylsulfonic acid and/or the arylsulfonic acid is preferably a derivative of aminoethanesulfonic acid, examples of which include: aminoethanesulfonic acid (taurine), N,N-bis(2-hydroxyethyl)-2-aminoethanesulfonic acid (BES), N-cyclohexyl-2-aminoethanesulfonic acid (CHES), 2-[4-(2-hydroxyethyl)-1-piperazinyl]ethanesulfonic acid (HEPES), 2-morpholinoethanesulfonic acid monohydrate (MES), piperazine-1,4-bis(2-ethanesulfonic acid) (PIPES), piperazine-1,4-bis(2-ethanesulfonic acid), sesquisodium salt, monohydrate (PIPES sesquisodium), and N-tris(hydroxymethyl)methyl-2-aminoethanesulfonic acid (TES).

According to a preferred embodiment of the present invention, the alkylsulfonic acid and/or the arylsulfonic acid is preferably a derivative of aminopropanesulfonic acid, examples of which include: aminopropanesulfonic acid, N-cyclohexyl-3-aminopropanesulfonic acid (CAPS), 3-[4-(2-hydroxyethyl)-1-piperazinyl]propanesulfonic acid (EPPS), 2-hydroxy-3-[4-(2-hydroxyethyl)-1-piperazinyl]propanesulfonic acid monohydrate (HEPPSO), 3-morpholinopropanesulfonic acid (MOPS), 2-hydroxy-3-morpholinopropanesulfonic acid (MOPSO), piperazine-1,4-bis(2-hydroxy-3-propanesulfonic acid),dihydrate (POPSO), N-tris(hydroxymethyl)methyl-3-aminopropanesulfonic acid (TAPS), and 2-hydroxy-N-tris(hydroxymethyl)methyl-3-aminopropanesulfonic acid (TAPSO).

According to a particularly preferred embodiment of the present invention, taurine (aminoethanesulfonic acid) can be most suitably used as the acid component. Taurine is a food additive used in flavoring materials as a umami component, and is a substance with such a high level of safety for humans as to be comprised as a medicinal component in eye-drops or the like which have become commercially available recently, as well as to be used as a nutritional supplement for baby formula in the United States. In addition, taurine is a highly biodegradable and has a low accumulative property, therefore if it leaks out, the burden on the environment is extremely low. Since taurine has low metallic corrosion properties in spite of its acidity working to neutralize and eliminate a nitrogen-based odor, it has a benefit of being able to be applied to metal articles or metal-plated articles without hesitation. Further, taurine can be used by being mixed in an arbitrary ratio with a copper salt or zinc salt of a low concentration which is a coexisting component. Hence, by use of taurine in combination with a sulfate or gluconate which is also employed as a food additive, it is possible to attain an extremely safe deodorizer.

According to a preferred embodiment of the present invention, the alkylsulfonic acid and/or the arylsulfonic acid or a derivative thereof is comprised in the deodorizer in an amount of preferably 0.5 mM or more, more preferably 0.5 to 120 mM, further preferably 1 to 100 mM.

The solvent component used in the deodorizer of the present invention is water. According to a preferred embodiment of the present invention, the solvent may further comprise alcohol having 2 or 3 carbon atoms for the purpose of imparting long-lasting qualities for preventing the deodorizer from being contaminated by microorganisms, or of imparting a penetrating property of the deodorizer into a gap, a porous member or the like. The content of the alcohol in the total weight of the deodorizer is preferably 5 to 40% by weight, more preferably 10 to 25% by weight. When the alcohol content is within the above range, the resulting deodorizer has satisfactory long-lasting qualities and penetrating property, and is also superior in long-term stability because it is capable of effectively preventing the precipitation of other dissolved coexisting components.

According to a preferred embodiment of the present invention, the deodorizer preferably has a pH of 3 to 10, more preferably 4 to 9. A deodorizer within such a pH range is not irritating to the human organism and is free from the possibility of dirtying or damaging a member to which it is applied. The above pH range may be achieved by adjusting the concentrations of the salt component and the acid component or, in the alternative, by adding a pH adjustor into a liquid that has been adjusted to have desired concentrations of the salt component and the acid component. As such a pH adjustor, an inorganic oxoacid or a hydroxide can be preferably used. According to a more preferred embodiment of the present invention, the deodorizer preferably has a pH of 4 to 9, more preferably 4.5 to 7, from the viewpoints of skin irritation, safety, the effect on the member to which the deodorizer is applied and the like. In particular, in the case of using a zwitterionic amino group-containing sulfonic-acid compound (aminosulfonic acid) as the odor eliminating component, the pH of the liquid agent is preferably set near the isoelectric point of the aminosulfonic acid. In this case, a preferred pH range is ±1.0 of the isoelectric point of the aminosulfonic acid. The smaller the difference between the pH of the liquid agent and the isoelectric point of the aminosulfonic acid, the smaller the dissociation of the aminosulfonic acid becomes, resulting in minimized interaction with the metal ion. Designing the deodorizer in this manner makes it possible to maximize the odor prevention/elimination effect of the metal ion comprised at a low concentration and also to freely work out the odor elimination effect.

Use and Using Method

According to a preferred embodiment of the present invention, the deodorizer of the present invention is preferred to be used on an area or in a space out of contact with water under normal use condition, in particular on an area or an article where the removal of dirt therefrom is difficult by cleaning or washing in water as is done in the case of dish washing or laundry. Such an area will exist, for example, in a water-using space, such as a toilet, a bathroom and a kitchen; on a textile product; on shoes; or on a wall covering material. Specifically, examples of such an area in the toilet include: a gap created in a region of contact between the western style toilet skirt and the floor; a gap created in a region of contact between the western-style toilet and the wall; a gap created between the seat and the seat mounting face; a gap created in a connecting region between the seat cover and the seat; a gap created in the contact region between the main body of a local washing device and the seat mounting face; a gap created between the seat and the tank; a gap created in a region of contact between a Japanese-style toilet and the floor; a gap created in a movable portion of a seat cover, a seat mounting face or the like of a portable toilet; and a gap created in the seam or the cement joint- between panel-type building materials used as finishing materials on the floor or the wall. Examples of such an area also include: the seam between panels forming the wall or the back face of the apron of the bathtub in the bathroom; a gap between the wall and the washbasin in a lavatory; and various points in a gas-stove grill, around the drain outlet, around the drainpipe, and a gap between the wall and the kitchen unit, in the kitchen. Examples of articles used outside the water-using space include textile products, such as dry-clean only clothes, bedding such as a futon and a pillow, a carpet, a tatami mat; shoes; and the surface of the wall covering material such as porous building materials having recently received attention as the breathing wall material. Causative agents of odors, such as sebum, urine, perspiration and excretion are apt to accumulate on the above-described areas or articles, and additionally they deteriorate to produce offensive odors so that the offensive odors can be absorbed into the areas or articles, easily resulting in the emission source of the offensive odors hanging in the air. In addition, if a colored trace is left on the areas or articles by the use of a deodorizer, the trace is not washed away, considerably deteriorating the aesthetic appearance. Thus, when the deodorizer of the present invention is used for the aforementioned areas and articles, it is possible to directly exert the effect of preventing occurrence of an odor on the emission source as well as the effect of eliminating the odor which has been absorbed to the emission source due to the deterioration of the causative agent, without leaving any colored trace on the application site. In consequence, the superior deodorizing effect is exercised without deteriorating the aesthetic appearance of the application site. It goes without saying that the deodorizer of the present invention can be used for an area in contact with water under normal use condition, and may be sprayed into the space for eliminating the odor hanging therein. The deodorizer of the present invention is particularly suitable to use for preventing and eliminating odors of and from toilets, baby-related products, pet-related products, caring-related products, and nursing-related products. The deodorizer of the present invention can be applied by well-known techniques such as, but not limited to, spraying or coating.

The method for applying the deodorizer can employ an arbitrary method such as spraying or coating. Among them, the spraying such as trigger spray or aerosol spray is preferable for effectively applying the deodorizer evenly over a site to be applied, such as a space, an article, a gap created in an article, and the like, so as to fully exert the function of the deodorizer. In particular, a trigger spray is preferred comprising a container filled with a liquid agent and a spraying device which is manually operated and mounted detachably from the container because the trigger spray can be refilled with a liquid agent and is made economical. When the deodorizer is required to be sprayed into a space, the use of a trigger making the particle diameter smaller is desirable. Specifically, it is preferred that the particles having a particle diameter of 150 μm or less comprises 75% or less in a volume distribution. The particle diameter described herein means a particle diameter of the particles immediately after being sprayed from a spray device. More specifically, a particle size distribution measuring apparatus manufactured by Tohnichi Computer Applications Corporation (LDSA-3400A) is used to make three measurements of the particle size of the particles passing through a point located at 10 cm away from the leading end of the spray device after by a laser light scattering technique. The measured values are added and averaged. The Rosin-Rammler distribution function is used to calculate the average particle diameter of the sprayed particles and the calculated particle diameter is shown. When the deodorizer is required to be applied to tile joint, the full surface of the floor or the wall, or the entire toilet or urinal, it is preferred to use a trigger having an increased spray pattern diameter or a trigger spraying an increased amount of liquid agent. Specifically, the spray pattern diameter preferably reaches 10 cm or more. The spray patter diameter described herein means a spray patter diameter obtained by the steps of spraying a liquid agent from the leading end of the spray device perpendicularly toward a paper sheet having a high water-absorbing rate, determining the area of the paper sheet on which the liquid agent deposits by visual observation, and measuring the major axis (cm) of the area with a ruler. The amount of spraying of the spraying device preferably ranges from 0.1 to 3.0 g per stroke. The amount of 0.1 g or less increases the number of strokes for spraying the amount of liquid agent required for eliminating/preventing odor, resulting in inconvenience of operation in use. The amount of 3.0 g or more locally increases the amount of spray, resulting in insufficient exhibition of the advantageous effects of the present invention. Regarding to the deodorizer of the present invention, the required amount of deodorizer sprayed for eliminating/preventing odor generally ranges 0.1 to 10 g, depending on the size of the toilet space to which it is applied as well as on types and amount of components in the liquid composition. When the deodorizer is applied to articles and gaps created in the articles, it is preferred to use the trigger capable of varying the particle diameter and the spray pattern diameter.

### EXAMPLES

The present invention will be described in more detail with reference to the following examples, but the present invention is not limited to these examples.

### Examples 1 to 33

(1) Preparation of Deodorizers

The following raw materials were prepared.

Salt Component

Copper gluconate (produced by Fuso Chemical Co., Ltd.)

Zinc gluconate (produced by Fuso Chemical Co., Ltd.)

Acid Component

Aminoethanesulfonic acid (produced by Kanto Chemical Co., Inc.)

Aminomethanesulfonic acid (produced by Wako Pure Chemical Industries, Ltd.)

Benzenesulfonic acid (produced by Wako Pure Chemical Industries, Ltd.)

Sulfanilic acid (produced by Wako Pure Chemical Industries, Ltd.)

Amidosulfuric acid (produced by Kanto Chemical Co., Inc.)

p-toluenesulfonic acid (produced by Wako Pure Chemical Industries, Ltd.)

2-[4-(2-hydroxyethyl)-1-piperazinyl]ethanesulfonic acid (HEPES) (Dojindo Laboratories)

3-morpholinopropanesulfonic acid (MOPS) (Dojindo Laboratories)

N-tris(hydroxymethyl)methyl-3-aminopropanesulfonic acid (TAPS) (Dojindo Laboratories)

Phosphoric acid (produced by Kanto Chemical Co., Inc., used in comparative examples)

Citric acid (produced by Fuso Chemical Co., Ltd., used in comparative examples)

Glycin (produced by Iwata Chemical Co., Ltd., used in comparative examples)

pH Adjustor

Sodium hydrate (produced by Wako Pure Chemical Industries, Ltd.)

Solvent

Water

2-propanol (produced by Wako Pure Chemical Industries, Ltd.)

Ethanol (produced by Wako Pure Chemical Industries, Ltd.)

Solvents having compositions shown in Tables 1 to 3 were prepared. The various salt components and acid components were added and mixed into the solvents to reach the concentrations (mM) shown in Tables 1 to 3. The pH adjustors were added into the resulting solvents in Examples 20 to 33 to adjust the pH of the solvents to fall within a range of 5±0.5. Thus, the deodorizers of various compositions were obtained.

(2) Evaluation of Deodorizer

The various deodorizers thus obtained were subjected to evaluations as described below.

Evaluation 1: Odor Prevention Test

With the deodorizers of Examples 1 to 33, tests for evaluating the odor prevention performance based on inhibition of enzyme activity were performed as described below. First, a closed glass vessel of 40φ×75 mm with a capacity of 60 mL was provided. 0.15 g of 1500 ppm urease aqueous solution (produced by Wako Pure Chemical Industries, Ltd., derived from sword beans, 80 to 150 units/mg), and 1 g of each of the deodorizers of Examples 1 to 33 were added into the glass vessel to be mixed together for one hour. Then, 2 g of 10% urea water was added to the mixture. After the expiration of 24 hours, an ammonia odor occurring from the vessel was evaluated by the organoleptic examination based on the odor intensity criteria as shown below. In the organoleptic examination, a deodorizer with odor intensity 2 or lower was evaluated as “G” (good), while a deodorizer with odor intensity 2 or higher was evaluated as “NG” (not good). Tables 1 to 4 show the results of the evaluations.

Odor intensity 5: Distinct odor

Odor intensity 4: Perceivable odor after taking a strong sniff

Odor intensity 3: Slightly Perceivable odor

Odor intensity 2: Hardly Perceivable odor

Odor intensity 1: No odor at all

Evaluation 2: Odor Elimination Test 1 (TMA)

With each of the deodorizers of Examples 1 to 33, the odor elimination test in terms of trimethylamine (TMA) was conducted as described below. A trimethylamine solution was poured into a 5 L Tedlar bag in such a manner as to reach an initial concentration of 15 ppm, then 1.0 g of the deodorizer was added thereto, and then pure air was charged into the Tedlar bag. After the expiration of 5 minutes, the trimethylamine concentration was measured by the detector tube method. The trimethylamine concentration thus measured and the trimethylamine initial concentration previously measured by the detector tube method before the addition of the deodorizer were used to calculate the odor elimination rate (%) in terms of trimethylamine on the basis of the following equation:
Odor elimination rate (%)=[(C_{TMA0}−C_{TMA1})/C_{TMA0}]×100
wherein C_{TMA0} is the trimethylamine initial concentration, and C_{TMA1} is the trimethylamine concentration measured when five minutes has elapsed from the time when the deodorizer was added.

A deodorizer with 60% or more of odor elimination rate was evaluated as “G” (good), while a deodorizer with 60% or less of odor elimination rate was evaluated as “NG” (not good). Tables 1 to 3 show the results of the evaluations.

Evaluation 3: Odor Elimination Test 2 (MM)

With each of the deodorizers of Examples 20 to 33, the odor elimination test in terms of methyl mercaptan (MM) was conducted as described below. The 10 ppm methyl mercaptan and 2.44 g of the deodorizer (1%) were added into a 5 L Tedlar bag. After the expiration of 5 minutes, the methyl mercaptan concentration was measured by the detector tube method. The methyl mercaptan concentration thus measured and the methyl mercaptan initial concentration previously measured by the detector tube method were used to calculate the odor elimination rate (%) in terms of methyl mercaptan on the basis of the following equation:
Odor elimination rate (%)=[(C_{MM0}−-C_{MM1})/C_{MM0}]×100
wherein C_{MM0} is the methyl mercaptan initial concentration, and C_{MM1} is the methyl mercaptan concentration measured when five minutes has elapsed from the time when the deodorizer was added.

A deodorizer with 30% or more of odor elimination rate was evaluated as “G” (good), while a deodorizer with 30% or less of odor elimination rate was evaluated as “NG” (not good). Table 3 shows the results of the evaluations.

Evaluation 4: Deodorizing Test in Toilet Application

With each of the deodorizers of Examples 1, 7, 19, and 20, the odor prevention performance against a toilet was evaluated by 20 monitors who answered that the toilet space has a distinctive offensive odor. First, the deodorizer was charged into a trigger-type spray pump (Z-305 series, manufactured by Mitani Valve Co., Ltd.). Then, the deodorizer was sprayed once from a distance of 10 cm toward each of the gaps created between the seat and the seat mounting face and created in the contact area between the western-style toilet skirt and the floor. In addition, the deodorizer was sprayed three times from a distance of 50 cm toward the water tank inside the western-style toilet. Further, the deodorizer was sprayed five times toward the center of the toilet space from the height of 150 cm at the entrance of the restroom. The change in odor intensity in the toilet space after the spray had been evaluated for a week by the organoleptic examination according to the same odor intensity criteria as Evaluation 1. In comparison with the odor intensities of the odors before the deodorizers were applied, i.e., at the beginning of the test, a deodorizer with which the odor intensity of the odor reduced by 2 points or more after the expiration of a week was evaluated as “G” (good), while a deodorizer with which the odor intensity did not reduce or reduced by less than 2 points was evaluated as “NG” (not good) (the determination was made by the mean value of the evaluations by the 20 monitors). Tables 1, 2, and 4 show the results of the evaluations.

Evaluation 5: Deodorizing Test in Caring Application

With each of the deodorizers of Examples 4, 8, 19, and 20, the odor prevention performance against a futon used by a care receiver were evaluated by 20 monitors who answered that the house where the elderly care receiver lives has an offensive odor. First, the deodorizer was charged into a trigger-type spray pump (Z-305 series, manufactured by Mitani Valve Co., Ltd.). Then, the deodorizer was sprayed once from a distance of 10 cm toward the futon. The deodorizer was sprayed once every two days from a distance of 50 cm toward the futon such that the liquid agent is applied evenly over the entire futon. The change in odor intensity in the space in which the futon after the deodorizer application is placed had been evaluated for a week by the organoleptic examination according to the same odor intensity criteria as Evaluation 1. In comparison with the odor intensities of the odors before the deodorizers were applied, i.e., at the beginning of the test, a deodorizer with which the odor intensity reduced by 1 point or more after the expiration of a week was evaluated as “G” (good), while a deodorizer with which the odor intensity did not reduce or reduced by less than 1 point was evaluated as “NG” (not good) (the determination was made by the mean value of the evaluations by the 20 monitors). Tables 1, 2 and 4 show the results of the evaluations.

Evaluation 6: Coloring Evaluation Test

With each of the deodorizers of Examples 1, 17, and 20, the test for evaluating the undesirable coloring properties was conducted as described below. First, a white cotton cloth was immersed into the deodorizer, then removed therefrom and then dried as it is. Then, the dried cloth was compared with another cotton cloth which was subjected to the same process using water instead of the deodorizer. The change of color tone as a result of the comparison was observed visually. In comparison with the cotton cloth subjected to the same process using water, a deodorizer with no change in color tone was evaluated as “G” (good), while a deodorizer with which a change in color tone was virtually observed was evaluated as “NG” (not good). Tables 1, 2, and 4 show the results of the evaluations. The deodorizer of comparative Example 17 changed the white color of the cotton cloth into a light blue color.

TABLE 1

| | Example No. | | | | | | | |
|---|---|---|---|---|---|---|---|---|
| | 1 | 2 | 3 | 4 | 5 | 6 | 7 | 8 |
| Salt component concentration (mM) | | | | | | | | |
| Copper gluconate | 0.01 | — | 0.01 | — | 0.01 | — | 1 | — |
| Zinc gluconate | — | 0.05 | — | 0.05 | — | 0.05 | — | 2 |
| Acid component concentration (mM) | | | | | | | | |
| Aminoethanesulfonic acid | 20 | 20 | — | — | — | — | 20 | 20 |
| Aminomethanesulfonic acid | — | — | 22.5 | 22.5 | — | — | — | — |
| Benzenesulfonic acid | — | — | — | — | 14.2 | 14.2 | — | — |
| Phosphoric acid | — | — | — | — | — | — | — | — |
| Citric acid | — | — | — | — | — | — | — | — |
| Glycin | — | — | — | — | — | — | — | — |
| Solvent composition (wt %) | | | | | | | | |
| Water | 100% | 100% | 100% | 100% | 100% | 100% | 100% | 100% |
| Evaluation result | | | | | | | | |
| Evaluation 1: Odor prevention test | G | G | G | G | G | G | G | G |
| Evaluation 2: Odor elimination | G | G | G | G | G | G | G | G |
| test 1 (TMA) | | | | | | | | |
| Evaluation 4: Deodorizing test | G | — | — | — | — | — | G | — |
| in toilet application | | | | | | | | |
| Evaluation 5: Deodorizing test | — | — | — | G | — | — | — | G |
| in caring application | | | | | | | | |
| Evaluation 6: Coloring evaluation test | G | — | — | — | — | — | — | — |

TABLE 2

| | Example No. | | | | | | | | | | |
|---|---|---|---|---|---|---|---|---|---|---|---|
| | 9* | 10* | 11* | 12* | 13* | 14* | 15* | 16* | 17* | 18* | 19* |
| Salt component concentration (mM) | | | | | | | | | | | |
| Copper gluconate | 0.01 | — | 0.01 | — | 0.01 | — | 0.01 | — | 10 | 0.001 | — |
| Zinc gluconate | — | 0.05 | — | 0.05 | — | 0.05 | — | 0.05 | — | — | — |
| Acid component concentration (mM) | | | | | | | | | | | |
| Aminoethanesulfonic acid | — | — | — | — | — | — | — | — | — | — | — |
| Aminomethanesulfonic acid | — | — | — | — | — | — | — | — | — | — | 20 |
| Benzenesulfonic acid | — | — | — | — | — | — | — | — | 14.2 | — | — |
| Phosphoric acid | 25.5 | 25.5 | — | — | — | — | — | — | — | — | — |
| Citric acid | — | — | 18.7 | 18.7 | — | — | — | — | — | — | — |
| Glycin | — | — | — | — | 33.3 | 33.3 | — | — | — | — | — |
| Solvent composition (wt %) | | | | | | | | | | | |
| Water | 100% | 100% | 100% | 100% | 100% | 100% | 100% | 100% | 100% | 100% | 100% |
| Evaluation result | | | | | | | | | | | |
| Evaluation 1: Odor prevention test | NG | NG | NG | NG | NG | NG | NG | NG | G | NG | NG |
| Evaluation 2: Odor elimination | G | G | G | G | G | G | NG | NG | G | NG | G |
| test 1 (TMA) | | | | | | | | | | | |
| Evaluation 4: Deodorizing test | — | — | — | — | — | — | — | — | — | — | NG |
| in toilet application | | | | | | | | | | | |
| Evaluation 5: Deodorizing test | — | — | — | — | — | — | — | — | — | — | NG |
| in caring application | | | | | | | | | | | |
| Evaluation 6: Coloring evaluation test | — | — | — | — | — | — | — | — | NG | — | — |

*Comparative Example

TABLE 3

| | Example No. | | | | | | | | | | | | | |
|---|---|---|---|---|---|---|---|---|---|---|---|---|---|---|
| | 20 | 21 | 22 | 23 | 24 | 25 | 26 | 27 | 28 | 29 | 30 | 31* | 32* | 33* |
| Salt component | | | | | | | | | | | | | | |
| concentration (mM) | | | | | | | | | | | | | | |
| Copper gluconate | 0.5 | 0.5 | 0.5 | 0.5 | 0.5 | 0.5 | 0.5 | 0.5 | 0.5 | 0.5 | 0.5 | 0.5 | 0.5 | 0.5 |
| Acid component | | | | | | | | | | | | | | |
| concentration (mM) | | | | | | | | | | | | | | |
| Aminoethanesulfonic | 20 | — | — | — | — | — | 20 | | — | — | — | — | — | — |
| acid | | | | | | | | | | | | | | |
| Aminomethanesulfonic | — | 22.5 | — | — | — | — | — | 22.5 | — | — | — | — | — | — |
| acid | | | | | | | | | | | | | | |
| Sulfanilic acid | — | — | 14.5 | — | — | — | — | — | — | — | — | — | — | — |
| Amidosulfuric acid | — | — | — | 25.8 | — | — | — | — | — | — | — | — | — | — |
| p-toluenesulfonic | — | — | — | — | 13.1 | — | — | — | — | — | — | — | — | — |
| acid | | | | | | | | | | | | | | |
| Benzenesulfonic | — | — | — | — | — | 14.2 | — | — | — | — | — | — | — | — |
| acid | | | | | | | | | | | | | | |
| HEPES | — | — | — | — | — | — | — | — | 10.5 | — | — | — | — | — |
| MOPS | — | — | — | — | — | — | — | — | — | 12.0 | — | — | — | — |
| TAPS | — | — | — | — | — | — | — | — | — | — | 10.3 | — | — | — |
| Phosphoric acid | — | — | — | — | — | — | — | — | — | — | — | 25.5 | — | — |
| Citric acid | — | — | — | — | — | — | — | — | — | — | — | — | 18.7 | — |
| Glycin | — | — | — | — | — | — | — | — | — | — | — | — | — | 33.3 |
| pH adjustor | | | | | | | | | | | | | | |
| Sodium hydrate | The amount required to adjusting liquid property to pH 5 ± 0.5 | | | | | | | | | | | | | |
| Solvent | | | | | | | | | | | | | | |
| composition (wt %) | | | | | | | | | | | | | | |
| Water | 75 | 80 | 100 | 100 | 100 | 100 | 60 | 80 | 100 | 100 | 100 | 100 | 100 | 100 |
| Ethanol | 25 | — | — | — | — | — | 40 | — | — | — | — | — | — | — |
| 2-propanol | — | 20 | — | — | — | — | — | 20 | — | — | — | — | — | — |

*Comparative Example

TABLE 4

| | Example No. | | | | | | | | | | | | | |
|---|---|---|---|---|---|---|---|---|---|---|---|---|---|---|
| Evaluation result | 20 | 21 | 22 | 23 | 24 | 25 | 26 | 27 | 28 | 29 | 30 | 31* | 32* | 33* |
| Evaluation 1: Odor | G | G | G | G | G | G | G | G | G | G | G | NG | NG | NG |
| prevention test | | | | | | | | | | | | | | |
| Evaluation 2: Odor | G | G | G | G | G | G | G | G | G | G | G | G | G | G |
| elimination test 1 (TMA) | | | | | | | | | | | | | | |
| Evaluation 3: Odor | G | G | G | G | G | G | G | G | G | G | G | NG | NG | NG |
| elimination test 2 (MM) | | | | | | | | | | | | | | |
| Evaluation 4: Deodorizing | G | — | — | — | — | — | — | — | — | — | — | — | — | — |
| test in toilet application | | | | | | | | | | | | | | |
| Evaluation 5: Deodorizing | G | — | — | — | — | — | — | — | — | — | — | — | — | — |
| test in caring application | | | | | | | | | | | | | | |
| Evaluation 6: Coloring | G | — | — | — | — | — | — | — | — | — | — | — | — | — |
| evaluation test | | | | | | | | | | | | | | |

*Comparative Example

1. A deodorizer comprising:
a salt of copper (II) ion and/or zinc ion;
at least one acid component selected from the group consisting of alkylsulfonic acids having 1 to 6 carbon atoms, arylsulfonic acids having 5 to 14 carbon atoms, amidosulfuric acids, and derivatives thereof, wherein the acid component may be substituted by at least one selected from the group consisting of amine groups, imine groups, and hydroxyl group; and
water being a solvent,
wherein the deodorizer comprises the salt in an amount of more than 0.001 mM and less than 10 mM.

2. A deodorizer according to claim 1, wherein the salt has a LD50 of 300 to 2000 mg/kg.

3. A deodorizer according to claim 1, wherein the salt is selected from the group consisting of gluconates, sulfates, malates, and lactates.

4. A deodorizer according to claim 1, wherein the salt is a gluconate.

5. A deodorizer according to claim 1, comprising the salt in an amount of 0.005 to 2 mM.

6. A deodorizer according to claim 1, comprising the salt in an amount of 0.02 to 1 mM.

7. A deodorizer according to claim 1, wherein
the alkylsulfonic acids and/or the arylsulfonic acids are selected from the group consisting of compounds represented by the following chemical structural formulas:
R¹—SO₃H (1)
wherein R¹ is an alkyl group having 1 to 6 carbon atoms, an aryl group having 5 to 14 carbon atoms, or an amine group having 1 to 6 carbon atoms; and 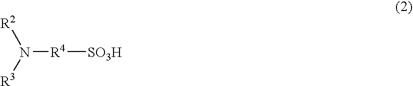
wherein R² and R³ are independently a hydrogen atom, an amine group, a hydroxyl group, a sulfonic group, a hydrocarbon group having 1 to 6 carbon atoms, or an aryl group having 5 to 14 carbon atoms, wherein at least one hydrogen atom of the alkyl group and the aryl group may be substituted by a hydroxyl group, an amine group, or a sulfonic group, provided that R² and R³ may be linked together to form a cyclic structure, and wherein R⁴ is an alkyl group having 1 to 6 carbon atoms or an aryl group having 5 to 14 carbon atoms, provided that at least one hydrogen atom of the alkyl group and the aryl group may be substituted by a hydroxyl group, an amine group, or a sulfonic group.

8. A deodorizer according to claim 7, wherein the acid component is selected from the group consisting of aminomethanesulfonic acid, aminoethanesulfonic acid, and benzenesulfonic acid.

9. A deodorizer according to claim 1, comprising the acid component in an amount of 0.5 mM or more.

10. A deodorizer according to claim 1, comprising the acid component in an amount of 0.5 to 120 mM.

11. A deodorizer according to claim 1, having a pH of 3 to 10.

12. A deodorizer according to claim 1, having a pH 4 to 9.

13. A deodorizer according to claim 11, further comprising an inorganic oxoacid and/or a hydroxide as a pH adjustor.

14. A deodorizer according to claim 1, further comprising being a solvent an alcohol having 2 or 3 carbon atoms.

15. A deodorizer according to claim 1, which is used for either an area or a space out of contact with water under normal use condition.

16. A deodorizer according to claim 1, which is used for an odor emission source selected from the group consisting of a water-using space, textile products, shoes, and wall-covering materials.

17. A method for using a deodorizer, comprising a step of applying the deodorizer according to claim 1 to either an area or a space out of contact with water under normal use condition.

18. A method according to claim 17, wherein the area out of contact with water under normal use condition exists in an odor emission source selected from the group consisting of a water-using space, textile products, shoes, and wall-covering materials.

19-20. (canceled)
